(19) United States
(12) Patent Application Publication
(10) Pub. No.: US 2025/0093259 A1
(43) Pub. Date: Mar. 20, 2025

(54) PURGE-FREE OPEN-PATH SYSTEM AND METHOD FOR CAVITY ENHANCED SPECTROSCOPY

(71) Applicant: Nikira Labs Inc., Mountain View, CA (US)

(72) Inventors: Manish Gupta, Mountain View, CA (US); John Brian Leen, Sunnyvale, CA (US); Rupal Gupta, Mountain View, CA (US); Nabil Saad, Menlo Park, CA (US); Andrew P. Chan, Rancho Santa Margarita, CA (US)

(21) Appl. No.: 18/817,594

(22) Filed: Aug. 28, 2024

Related U.S. Application Data
(60) Provisional application No. 63/538,977, filed on Sep. 18, 2023.

(51) Int. Cl. G01N 21/25; G01N 21/03; G01N 21/39

(52) U.S. Cl. CPC G01N 21/255; G01N 21/031; G01N 2021/391

(57) ABSTRACT

A method of measuring a quantity or characteristic of a qualified air, e.g., clean air or prefiltered air, present in an environment, e.g., a chamber or a cleanroom, includes freely placing a measurement apparatus with an open multipass cell in the environment, and allowing a qualified air, such as clean air or prefiltered air, present in the environment to move freely into and out of an optical cavity of the open multipass cell. The method further includes obtaining a measurement of a quantity or a characteristic based on the qualified air in the optical cavity.

### CROSS-REFERENCE TO RELATED APPLICATION

This application claims the benefit of U.S. Provisional Application Ser. No. 63/538,977, entitled “Purge-Free Open-Path System and Method for Cavity Enhanced Spectroscopy” and filed on Sep. 18, 2023, which is expressly incorporated by reference herein in its entirety.

### TECHNICAL FIELD

The present disclosure relates generally to optical absorption spectroscopy, and more particularly to a purge-free, open-path system and method for cavity enhanced spectroscopy.

### BACKGROUND

FIG. 1 is a schematic diagram of a known closed-cell system for measuring the optical absorption of a sample. The system includes a closed cell having an optical cavity with a pair of mirrors. A pump coupled to the closed cell draws the sample into the optical cavity. Because of this arrangement, this type of system is also referred to as a flow-through measurement system. The close-cell system includes additional components that are not shown for simplicity of illustration. These additional components includes for example, a light source, a light detector, optical coupling elements, and an analyzer. The light source and associated optical coupling elements output and direct a light beam having a wavelength corresponding to an absorption region of interest into the optical cavity. The light detector is optically coupled with the optical cavity and is configured to detect light that exits the optical cavity through a mirror. The analyzer is optically coupled with the light detector and is configured to measure the intensity of light of the wavelength corresponding to the absorption region of interest. Many samples of interest, however, are readily absorbed onto interior surfaces of the closed cell or are reactive and cannot be easily measured with the flow-through measurement system of FIG. 1. Examples of such samples include ammonia (NH₃) hydrogen fluoride (HF), acrolein, hydrogen chloride (HCl), and gases used in high molecular weight explosives and chemical weapons.

FIG. 2 is a schematic diagram of a known open-cell system for measuring the optical absorption of a sample. The system includes an open cell having an optical cavity with a pair of mirrors. Because of this arrangement, this type of system is also referred to as an open-path measurement system. In an open cell, sample gas can flow in and out of the optical cavity (i.e., the space between the cavity mirrors) without the use of a pump and with minimal wall interactions. Unfortunately, for multipass cells and for cavity enhance methods such as cavity enhanced absorption spectroscopy (CEAS), cavity ringdown spectroscopy (CRDS) and integrated cavity output spectroscopy (ICOS) that rely on extremely low loss mirrors, opening the cell to unfiltered air quickly results in contamination on the mirrors, which affects the performance of the multipass cell and the accuracy of the measurements obtained.

FIG. 3 is a schematic diagram of a known open-cell system for measuring the optical absorption of a sample that provides a solution to the problem of mirror contamination associated with the system of FIG. 2. The system of FIG. 3 includes an open cell having an optical cavity with a pair of mirrors and a purge system that introduces clean, pre-filtered purge air at each of the cavity mirrors. The purging air protects the surfaces of the mirrors from contamination by preventing contaminate from reaching the mirrors, or at least reducing the amount of contaminate that reaches the mirrors. A downside to the solution of FIG. 3 is the complexity that results of the inclusion of consumables (filters and pumps) required to supply the purge flow.

FIG. 4 is a schematic diagram of a known closed-cell system for measuring the optical absorption of a sample in a cleanroom environment. Such systems are used for example, in the semiconductor manufacturing industry, where cleanroom air quality monitoring for species that are caustic or corrosive to in-process wafers is critical to optimize yields and quality. The system is similar to that of FIG. 1 and includes a closed cell having an optical cavity with a pair of mirrors and a pump that draws a clean sample from the cleanroom environment into the optical cavity. These flow-through systems, however, struggle to attain desired sample response times because of sample line and cell wall adsorption of target analytes. Sample response times using a flow-through system as shown in FIG. 4 are typically on the single minute scale while an open multipass cell can have sub-second response time. A further downside to the closed-cell system of FIG. 4 is the complexity that results of the inclusion of a pump.

### SUMMARY

In one aspect, the disclosure relates to a method of measuring a quantity or characteristic of a qualified air, e.g., clean air or prefiltered air, present in an environment, e.g., a chamber or a cleanroom. The method includes freely placing a measurement apparatus with an open multipass cell in the environment, and allowing a qualified air, such as clean air or prefiltered air, present in the environment to move freely into and out of an optical cavity of the open multipass cell. The method further includes obtaining a measurement of a quantity or a characteristic based on the qualified air in the optical cavity.

Allowing qualified air within the environment to move freely into and out of the optical cavity comprises refraining from applying purge air onto or near the reflective surface of any of a plurality of mirrors of the optical cavity. As such, no purge air is present within the optical cavity that would interfere or impede the free movement of the qualified air into and out of the optical cavity. Also, there is no purge-air structure, e.g., tube, present within the optical cavity near the surface of the mirrors that would interfere or impede the free movement of the qualified air in the region of the mirror surfaces. Thus, allowing the qualified air within the environment to move freely into and out of the optical cavity can comprise exposing the entire reflective surface of each of the plurality of mirrors of the optical cavity to the qualified air in the optical cavity. Allowing qualified air within the environment to move freely into and out of the optical cavity also comprises refraining from forcing the qualified air into or out of the optical cavity. In this case, there is no air-pump structure, e.g., pump and air ducts or hose, associated with the open multipass cell.

Freely placing the measurement apparatus with an open multipass cell in the environment comprises refraining from physically connecting the apparatus to other structures, other than a power supply. For example, because the method refrains from applying purge air onto or near the reflective surfaces of the mirrors of the optical cavity the measurement apparatus does not have to be connected to a purge air source.

In another aspect, the disclosure relates to a system that includes an environment configured to contain qualified air and a measurement apparatus configured for placement in the environment. The measurement apparatus is also configured to obtain a measurement of a quantity or characteristic of the qualified air. The measurement apparatus includes an open multipass cell with an optical cavity having a space between a plurality of mirrors. The open multipass cell is configured to allow the qualified air to move freely into and out of the optical cavity. To this end, the measurement apparatus does not include a mechanism for applying purge air onto the surface of any of the plurality of mirrors of the optical cavity, and is configured such that the surfaces of each of the plurality of mirrors are fully exposed to the qualified air. The measurement apparatus also does not include a mechanism for pumping qualified air into the optical cavity. The measurement apparatus also includes an analyzer coupled to the open multipass cell. The analyzer is configured to measure a quantity or characteristic of the qualified air.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a schematic diagram of a known flow-through system for measuring a sample using a closed cell having an optical cavity with a pair of mirrors and a pump that drawings the sample into the optical cavity

FIG. 2 is a schematic diagram of a known open-path system for measuring a sample using an open cell having an optical cavity with a pair of mirrors, where contamination occurs at the surface of the mirrors.

FIG. 3 is a schematic diagram of a known open-path system for measuring a sample using an open cell having an optical cavity with a pair of mirrors and a purge system that introduces purge air at the surface of the mirrors to prevent contaminant from reaching the mirrors.

FIG. 4 is a schematic diagram of a known flow-through system for measuring a sample from a cleanroom environment using a closed cell having an optical cavity with a pair of mirrors and a pump that drawings the clean sample into the optical cavity.

FIG. 5A is a schematic diagram of a purge-free, open-path system having an environment, e.g., cleanroom, and a measurement apparatus for measuring a sample in the environment.

FIG. 5B is an illustration of a measurement apparatus for use in the system of FIG. 4B, having an analyzer coupled to an open multipass cell having an optical cavity with a pair of mirrors.

FIG. 6 is a method of measuring a sample using the system of FIG. 5A.

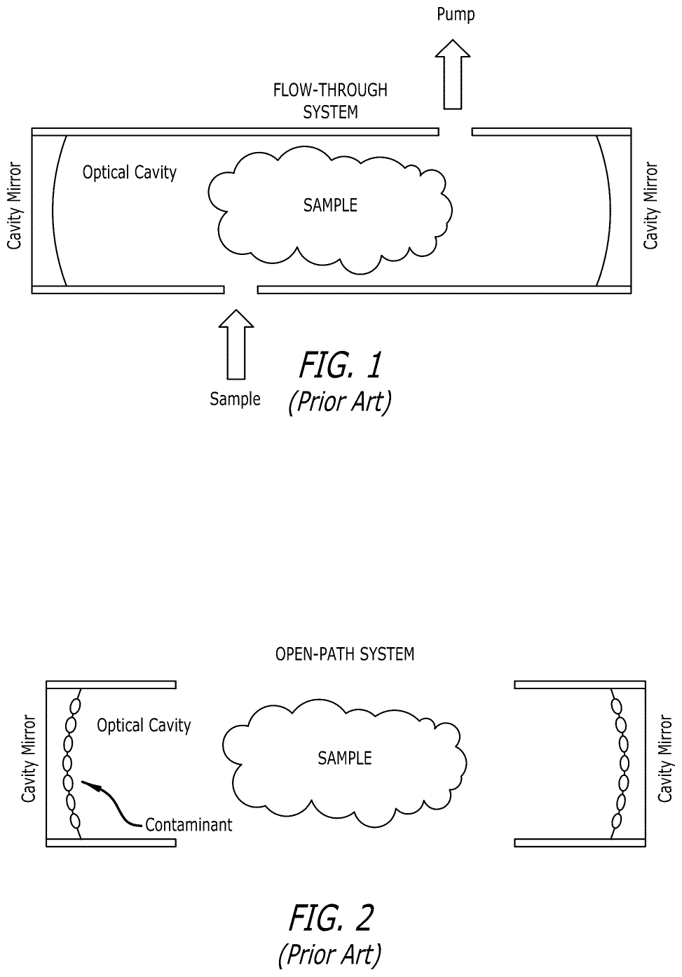

### DETAILED DESCRIPTION

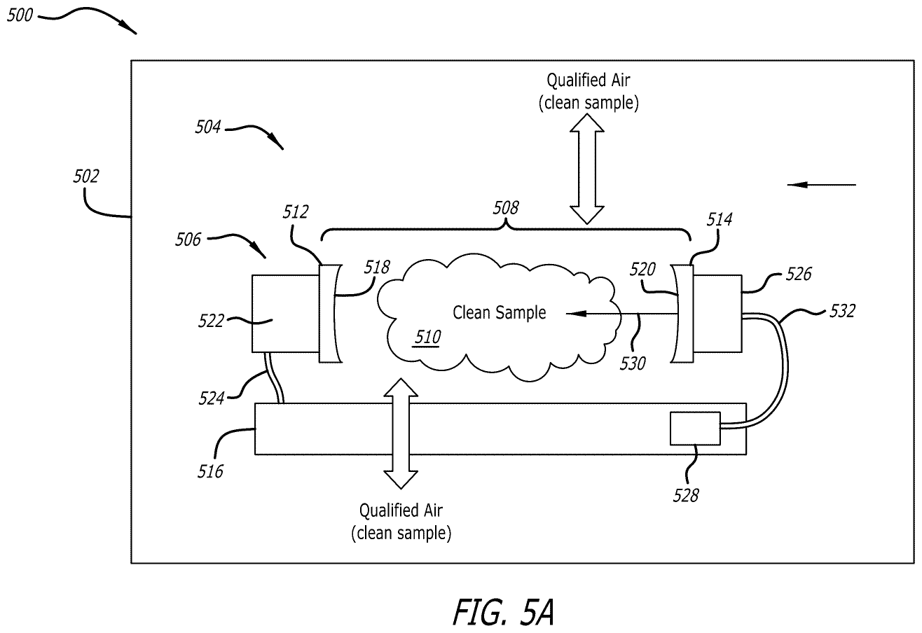

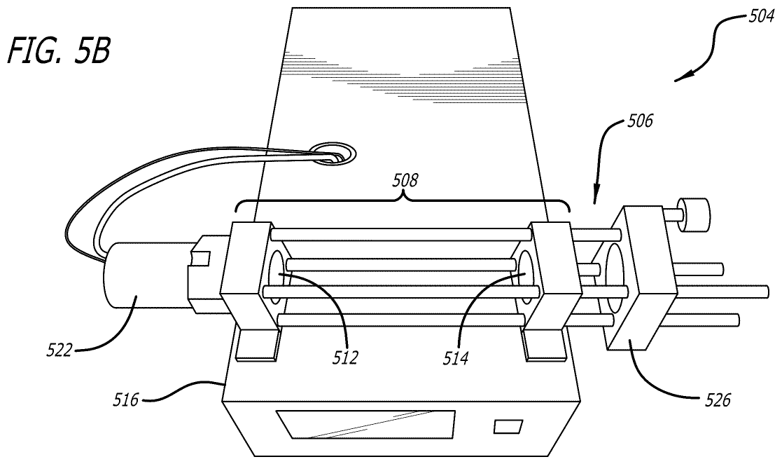

With reference to FIGS. 5A and 5B, disclosed herein is a purge-free, open-path system 500 for cavity enhanced spectroscopy. The system 200 includes an environment 502, configured to contain a qualified air, and a measurement apparatus 504 (FIG. 5B) configured for placement in the environment and to obtain a measurement of a quantity or characteristic of the qualified air. Example “environments” include chambers and cleanrooms. Example “qualified air” include clean air (e.g., liquified natural gas after volatilizing) and prefiltered air (e.g., biogenic natural gas before compressing).

The measurement apparatus 504 includes an open multipass cell 506 with an optical cavity 508 and an analyzer 516 coupled to the open multipass cell. The optical cavity 508 includes a space 510 between a plurality of mirrors 512, 514. The open multipass cell 506 is configured to allow the qualified air to move freely into and out of the optical cavity.

The plurality of mirrors include an input mirror 514 through which light passes into the optical cavity. To this end, the open multipass cell 506 includes a laser launch opto-mechanics 526 optically coupled with the input mirror 514. The light launch opto-mechanics 526 couples to a light source 528 through an optical cable 532 and is configured to transmit a light beam 530 through the input mirror, into the optical cavity 508. The input mirror 514 includes a reflective surface 520 having a reflectivity of at least a reflectivity greater than 99.9%.

The plurality of mirrors include an output mirror 512 through which light passes to the analyzer 516. To this end, the open multipass cell 506 includes a light detector 522 that is coupled to the analyzer through a detector signal cable 524. The output mirror 512 includes a reflective surface 518 having a reflectivity of at least a reflectivity greater than 99.9%.

Notably absent from the measurement apparatus 504 is a mechanism for applying purge air onto the surface 518, 520 of the mirrors 514, 512. Thus, the open multipass cell 506 is configured such that the surfaces 518, 520 of the mirrors 512, 514 are fully exposed to the qualified air. In other words, there is no purging-air apparatus associated with the open multipass cell 506 that would impede the free flow of air to the surfaces 518, 520 of the mirrors 512, 514.

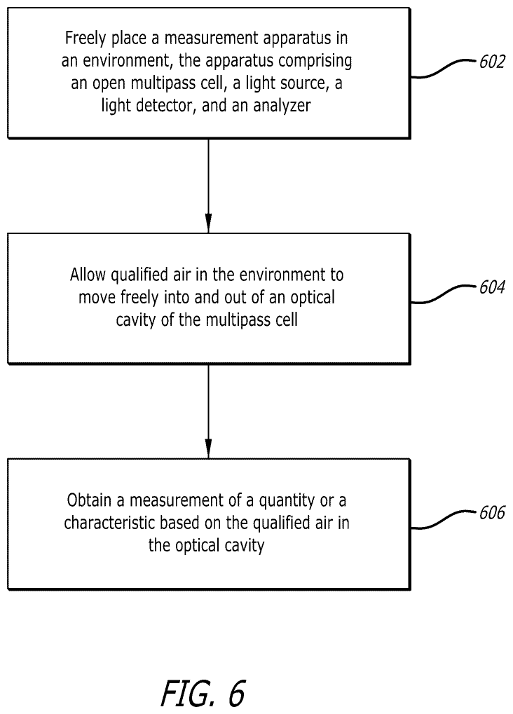

FIG. 6 is a method of measuring a quantity or characteristic of a qualified air in an environment. The method can be performed using the system of FIG. 5A.

At block 1602, a measurement apparatus 504 comprising an analyzer 516 and an open multipass cell 506 with an optical cavity 508 comprising a space 510 between a plurality of mirrors 512, 514 is freely placing in the environment 502. Freely placing the measurement apparatus 504 in the environment 502 comprises refraining from physically connecting the apparatus to other structures, other than a power supply. For example, because the measurement apparatus 504 does not rely on purge air the apparatus does not have to be connected to a purge air source.

At block 1604, qualified air within the environment to is allowed to move freely into and out of the optical cavity of the open multipass cell. To this end, there is no application of purge air onto or near the reflective surface of any of a plurality of mirrors of the optical cavity. As such, no purge air is present within the optical cavity that would interfere or impede the free movement of the qualified air into and out of the optical cavity. Also, there is no purge-air structure, e.g., tube, present within the optical cavity near the surface of the mirrors that would interfere or impede the free movement of the qualified air in the region of the mirror surfaces. Thus, allowing the qualified air within the environment to move freely into and out of the optical cavity can comprise exposing the entire reflective surface of each of the plurality of mirrors of the optical cavity to the qualified air in the optical cavity. Furthermore, there is no forcing of the qualified air into or out of the optical cavity. In other words, there is no air-pump structure, e.g., pump and air ducts or hose, associated with the open multipass cell.

At block 1606, a measurement of a quantity or a characteristic is obtained based on the qualified air in the optical cavity. To this end, directing a light beam 530 is directed into the optical cavity 508 through the input mirror 514 and a light beam 530 that exits the optical cavity through a second mirror 512 is detected and analyzed by the analyzer 516.

The system and method disclosed herein can be used to measure adsorptive and reactive species in a sample gas. For example, the system disclosed herein is applicable to cleanrooms for fabricating semiconductors or other dust sensitive components. In these environments, the air particle content is strictly controlled. The requirements for this are the same as standard filtering requirements for CEAS. Typically, this is removal of particles larger than 2 um in size. For the ISO 14644-1 Cleanroom Standards, this means that ISO 1 through ISO 4 are suitable for purge free operation of CEAS cells.

The system and method can also be used to measure a quantity of a sample gas that is prefiltered because of pre-existing or other application requirements. Some situations where this might occur would be closed vessel (chamber or pipe) where the sample gas flowing past is pre-filtered.

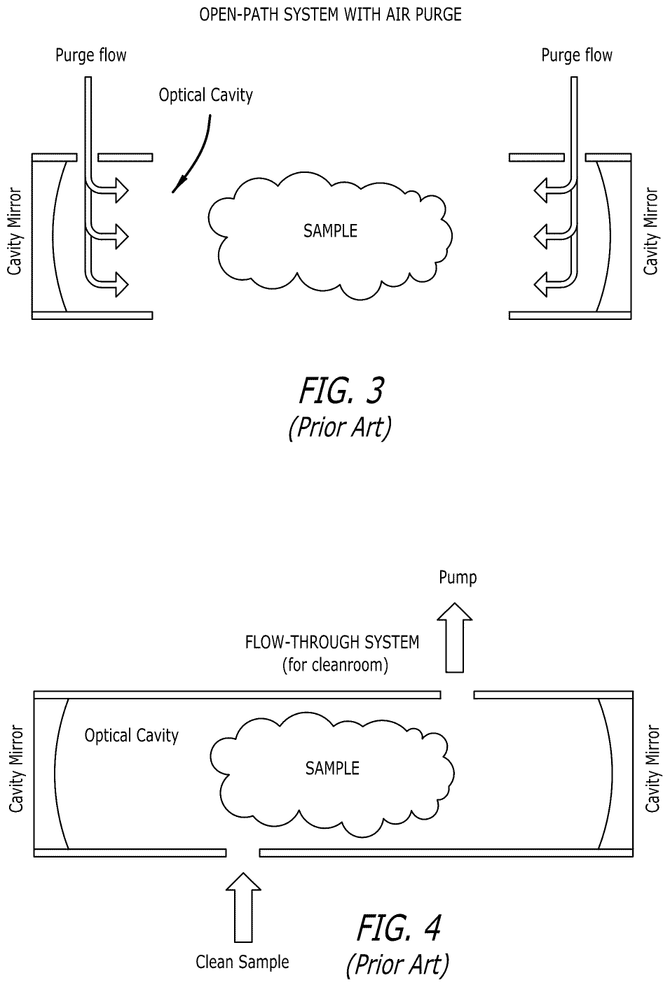

In either case, the cavity enhanced absorption spectroscopy analyzers can be operated without mirror protecting purge flow (such as shown in FIG. 3). The absence of a purge flow reduces the complexity of the apparatus and removes any consumables (filters and pumps) required to supply the purge flow. Removal of the purge requirements simplifies the apparatus, removing pumps that can fail and filters that can clog. Additionally, the spectroscopic analysis and calibration is simplified. Because the purge gas often does not contain the target species (e.g., adsorptive species are captured in the filter), part of the optical path has no sample and part does. This ratio must be measured and understood to obtain an accurate measurement of the target analyte. Worse, any changes to the purge flow can impact the ratio of sample-containing to sample-free path, which will result in measurement errors. If no purge is used, then the absorbing path can be determined in the standard way, e.g., measuring the cavity ringdown time or calibration during manufacture.

While the foregoing system includes an optical cavity and analyzer for cavity enhanced absorption spectroscopy (CEAS) measurements, the system may be configured with other types of analyzers that employ optical methods that require high reflectivity mirrors. For example, the system may be configured with optical cavities and analyzers for cavity ringdown spectroscopy (CRDS), integrated cavity output spectroscopy (ICOS), and other measurement methods that employ high multipass (e.g., more than, say, 50 passes) cells.

The various aspects of this disclosure are provided to enable one of ordinary skill in the art to practice the present invention. Various modifications to exemplary embodiments presented throughout this disclosure will be readily apparent to those skilled in the art. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method of measuring a quantity or characteristic of a qualified air present in an environment, the method comprising:
allowing the qualified air to move freely into and out of an optical cavity of an open multipass cell within the environment; and
obtaining a measurement of a quantity or a characteristic based on the qualified air in the optical cavity.

2. The method of claim 1, wherein a measurement of a quantity or a characteristic is obtained by a measurement apparatus comprising the open multipass cell and an analyzer coupled to the multipass cell, and further comprising freely placing the measurement apparatus in the environment.

3. The method of claim 1, wherein:
the optical cavity comprises a space between a plurality of mirrors, each having a reflective surface; and
allowing qualified air to move freely into and out of the optical cavity comprises refraining from applying purge air onto or near the reflective surface of any of the plurality of mirrors.

4. The method of claim 1, wherein:
each of the plurality of mirrors comprises a reflective surface; and
allowing the qualified air within the environment to move freely into and out of the optical cavity comprises exposing an entire reflective surface of each of the plurality of mirrors to the qualified air in the optical cavity.

5. The method of claim 1, wherein allowing qualified air to move freely into and out of the optical cavity comprises refraining from forcing the qualified air into or out of the optical cavity.

6. The method of claim 1, wherein obtaining a measurement of a quantity or a characteristic based on the qualified air in the optical cavity comprises:
directing a light beam into the optical cavity through a first mirror of a plurality of mirrors of the optical cavity; and
detecting a light beam that exits the optical cavity through a second mirror of the plurality of mirrors.

7. A system comprising:
an environment configured to contain qualified air; and
a measurement apparatus configured for placement in the environment and to obtain a measurement of a quantity or characteristic of the qualified air, the measurement apparatus comprising:
an open multipass cell with an optical cavity comprising a space between a plurality of mirrors wherein the open multipass cell is configured to allow the qualified air to move freely into and out of the optical cavity, and
an analyzer coupled to the open multipass cell.

8. The system of claim 7, wherein each of the plurality of mirrors is a high reflectivity mirror.

9. The system of claim 7, wherein:
each of the plurality of mirrors comprises a reflective surface; and
the measurement apparatus does not include a mechanism for applying purge air onto the reflective surface of any of the plurality of mirrors.

10. The system of claim 7, wherein the open multipass cell is configured such that a reflective surface of each of the plurality of mirrors is fully exposed to the qualified air.

11. The system of claim 7, wherein the open multipass cell further comprises a light detector and the analyzer is coupled to the light detector through a detector signal cable.

12. The system of claim 7, wherein the open multipass cell further comprises a laser launch opto-mechanics optically coupled with one of the mirrors and configured to couple to a laser source to transmit a light beam into the optical cavity.
